(19) United States
(12) Patent Application Publication
(10) Pub. No.: US 2026/0080025 A1
(43) Pub. Date: Mar. 19, 2026

(54) Resource Locator Prediction for Shortcut Generation

(71) Applicant: Google LLC, Mountain View, CA (US)

(72) Inventors: Lakshmi Kumar Dabbiru, Santa Clara, CA (US); Senthil Hariramasamy, Mountain View, CA (US)

(21) Appl. No.: 18/858,230

(22) PCT Filed: May 2, 2024
(86) PCT No.: PCT/US2024/027354

§ 371 Date: Oct. 18, 2024

Related U.S. Application Data
(60) Provisional application No. 63/500,998, filed on May 9, 2023.

(51) Int. Cl. G06F 16/957; G06F 16/953

(52) U.S. Cl. CPC G06F 16/9577; G06F 16/953

(57) ABSTRACT

In one example aspect, the present disclosure provides an example computer-implemented method for implementing a machine-learned action prediction model. The example method can include transmitting, by a computing system and to a search system, a search query for retrieving search results indicating web resources related to the search query. The example method can include receiving, by the computing system and from the search system, the search results. The example method can include determining, by the computing system and using a machine-learned action prediction model, based on context data associated with the search query, a resource locator of an action interface of a web resource associated with at least one search result. The example method can include generating, by the computing system, a shortcut to the action interface using the resource locator.

### PRIORITY

This application claims priority to and the benefit of U.S. Provisional Application No. 63/500,998 (filed May 9, 2023). U.S. Provisional Application No. 63/500,998 is hereby incorporated by reference herein in its entirety.

### FIELD

The present disclosure relates generally to machine learning. More particularly, the present disclosure relates to implementing machine-learned models to predict next actions.

### BACKGROUND

A computer can execute instructions to generate outputs provided some input(s) according to a parameterized model. The computer can use an evaluation metric to evaluate its performance in generating the output with the model. The computer can update the parameters of the model based on the evaluation metric to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In one example aspect, the present disclosure provides an example computer-implemented method for implementing a machine-learned action prediction model. The example method can include transmitting, by a computing system and to a search system, a search query for retrieving search results indicating web resources related to the search query. The example method can include receiving, by the computing system and from the search system, the search results. The example method can include determining, by the computing system and using a machine-learned action prediction model, based on context data associated with the search query, a resource locator of an action interface of a web resource associated with at least one search result. The example method can include generating, by the computing system, a shortcut to the action interface using the resource locator.

In one example aspect, the present disclosure provides an example computer-implemented method for training a machine-learned action prediction model. The example method can include obtaining, by a computing system, a training set of action sequences received from a browser application of a first set of client devices. The example method can include training, by the computing system, a machine-learned action prediction model to predict, for a respective training action sequence, an action based on one or more preceding actions in the respective training action sequence. The example method can include outputting, by the computing system, the trained machine-learned action prediction model to update a browser application of a second set of client devices, the browser application configured to use the trained machine-learned model to determine a resource locator of an action interface of a web resource associated with at least one search result presented within the browser.

In one example aspect, the present disclosure provides example non-transitory computer readable media storing instructions that are executable by one or more processors to cause a computing system to perform the example methods.

In one example aspect, the present disclosure provides an example computing system including the example non-transitory computer readable media. The example computing system can include the one or more processors.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of an example system for implementing machine-learned action prediction models according to example aspects of some embodiments of the present disclosure.

FIG. 2 is a block diagram of an example system for training a machine-learned action prediction model according to example aspects of some embodiments of the present disclosure.

FIG. 3 is a flow chart diagram of an example method for implementing a machine-learned action prediction model according to example aspects of some embodiments of the present disclosure.

FIG. 4 is a flow chart diagram of an example method for training a machine-learned action prediction model according to example aspects of some embodiments of the present disclosure.

FIG. 5 is a flow chart diagram illustrating an example method for training a machine-learned model according to example implementations of aspects of the present disclosure.

FIG. 6 is a block diagram of an example processing flow for using machine-learned model(s) to process input(s) to generate output(s) according to example implementations of aspects of the present disclosure.

FIG. 7 is a block diagram of an example sequence processing model according to example implementations of aspects of the present disclosure.

FIG. 8 is a block diagram of an example technique for populating an example input sequence for processing by a sequence processing model according to example implementations of aspects of the present disclosure.

FIG. 9 is a block diagram of an example model development platform according to example implementations of aspects of the present disclosure.

FIG. 10 is a block diagram of an example training workflow for training a machine-learned model according to example implementations of aspects of the present disclosure.

FIG. 11 is a block diagram of an inference system for operating one or more machine-learned model(s) to perform inference according to example implementations of aspects of the present disclosure.

FIG. 12 is a block diagram of an example networked computing system according to example implementations of aspects of the present disclosure.

FIG. 13 is a block diagram of an example computing device according to example implementations of aspects of the present disclosure.

FIG. 14 is a block diagram of an example computing device according to example implementations of aspects of the present disclosure.

Reference numerals that are repeated across plural figures are intended to identify the same features in various implementations.

### DETAILED DESCRIPTION

Example aspects of the present disclosure generally relate to machine-learned models for generating user interface elements that provide shortcuts to additional relevant content responsive to search queries. An example web search system can provide an interface for inputting search queries and retrieving results. The search results can include, for example, web resources relevant to the search query. The example system can use a machine-learned model to predict a destination for a relevant action to perform with a web resource in the search results. Based on the predicted relevant action, the example system can generate a shortcut element for presenting on the interface in conjunction with the web resource to enable direct loading of an action interface for performing the action. For instance, the destination can be another web resource configured for performing the action prediction (e.g., a related page of a website). The destination can include a resource locator (e.g., a URL) to the other web resource. The shortcut element can include a hyperlink that initiates loading of the web resource indicated by the resource locator.

For example, a user can use a client device to enter a search query into a search engine interface of an application (e.g., using a browser application). An example search query is “auto insurance.” The search engine can process the query to generate a list of search results. The search results can be web resources (e.g., web pages, web applications, etc.). For instance, the search results can include web pages or applications associated with auto insurance providers. The search engine can return the list of search results for display to the user.

The application can receive the search results and customize an interface for presenting the list based on user context. The application can use a machine-learned action prediction model to predict a destination associated with an action that the user intends to complete using a web resource returned in the list of search results. For example, the application can determine that the user is looking for a web resource to aid the user in submitting a request for an auto insurance quote. The application can use the machine-learned action prediction model to predict a destination that provides an action interface for performing the desired action. For instance, the application can use the machine-learned action prediction model to predict a resource locator (e.g., URL) pointing to a web page providing an interface for submission of a quote request.

The application can use the predicted destination resource locator to generate a shortcut to the destination web resource. The shortcut can include an additional interface input element for a user interface to render in association with the web resource returned in the search results. For instance, the web resource returned in the search results can be a web homepage for an auto insurance provider, www.FictionalAutoInsurance.com. The application can predict a destination providing an action interface for requesting a quote from that provider. For instance, the application can predict that www.FictionalAutoInsurance.com/GetQuote is the resource locator that provides a relevant destination. In addition to returning a hyperlink to www.FictionalAutoInsurance.com in the search results, the application can thus render an input element hyperlinking to www.FictionalAutoInsurance.com/GetQuote. In this manner, for instance, the application can predict a likely action to be taken and generate a shortcut to a destination most relevant for performing that action.

The machine-learned action prediction model can predict the destination for the action based on context data associated with the search query. For example, the context data can include the search query, prior search queries, other web resources loaded by the application, state or usage data from the client device, account data associated with a user account of the user, etc. The context data can be retrieved from a cache or storage on the client device or retrieved (e.g., periodically, in real time) from secure storage on a cloud storage server (e.g., associated with a user account of the user).

The machine-learned action prediction model can be implemented on-device or in the cloud. In on-device implementations, for example, context data cached on the device can be input to the machine-learned model. In this manner, for instance, additional communications with a cloud server can be avoided, decreasing latency and increasing security of the context data (e.g., by avoiding additional transmissions of the context data over a network, etc.).

The machine-learned action prediction model can be a lightweight model configured to operate on hardware with limited processing resources (e.g., limited processing bandwidth or speed, limited battery capacity, limited memory, etc.). The machine-learned action prediction model can be trained specifically for predicting next actions in a sequence of actions. The machine-learned action prediction model can be trained to directly output a resource locator for a next action.

The machine-learned action prediction model can be a sequence-to-sequence model configured to receive a sequence of prior actions (e.g., current or preceding resource locators of the user's journey) and generate a next action (e.g., a next resource locator). The machine-learned action prediction model can be or include a transformer architecture (e.g., encoder-decoder, encoder only, decoder only, etc.).

The machine-learned action prediction model can be trained on a corpus of action sequences to learn to predict likely next actions. The corpus of action sequences can be obtained by collecting, from a number of participating client devices, sequences of actions performed in a user journey. For instance, a user journey can include a search on a search engine, a selection and loading of a first result web resource, and a selection and loading of a page linked on that first result web resource. This sequence of actions can be cached on participating client devices, stripped of any personal identifiers, and uploaded to a training server to be a training example for training the machine-learned action prediction model.

The sequence of actions can include a sequence of resource locators. The resource locators can be tokenized and embedded into learned vector representations. The resource locators or representations thereof can be input to the machine-learned action prediction model for processing. The machine-learned action prediction model can predict the destination resource locator(s) by outputting one or more values corresponding to the destination resource locator (e.g., one or more tokens corresponding to the resource locator, a probability associated with one or more vocabulary entries associated with the resource locator, etc.).

At inference time, the machine-learned action prediction model can predict the destination based on context data. The context data can include one or more contemporaneous or prior actions (e.g., an action sequence containing one or multiple actions). The context data can include sensor data from the client device. The context data can include cached or logged data describing a usage history of the client device. The context data can be tokenized and input to the machine-learned action prediction model to generate the destination of a next action interface.

Example techniques of the present disclosure can provide a number of technical effects and benefits. A technical effect of example implementations of the present disclosure is decreased network transmissions. Retrieving web search results on a client device from a search system can involve transmitting and receiving data over a network connection. Each new web resource loaded generally requires additional data transmitted from a server hosting the web resource to the client device. By providing search results augmented by shortcuts to the most likely destinations, a computing system according to the present disclosure can provide a more direct path to the relevant web resources. By generating the shortcut based on the most likely destination, the system as a whole can decrease a number of required page loads for the most common action sequences. In this manner, for instance, the most common action sequences experienced by the system (e.g., the web servers, networking systems, network infrastructure, etc.) can be executed with decreased number of web resource/page loads.

Decreasing a number of separate web resource/page loads when accessing an action interface can decrease an amount of data transmitted over the network. This can decrease total bandwidth utilization of the network, or allow for a greater number of users to be served within the same data budget. Decreasing a number of separate web resources/pages that the user loads to access an action interface can decrease a number of processing cycles executed by the client device or server system. Decreased processing cycles can provide for more efficient energy use, prolonging operation in energy-constrained environments (e.g., battery-powered client devices). Decreased processing cycles can provide for lower power usage. Decreasing a number of separate web resources/pages that the user loads to access an action interface can decrease a memory allocation required for maintaining a browser. Decreased memory usage can provide for lower power usage.

In this manner, for instance, the improved energy efficiency of example implementations of the present disclosure can reduce an amount of pollution or other waste, thereby advancing the field of network-connected computing systems as a whole. The amount of pollution can be reduced in total (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Reference now is made to the figures, which provide example arrangements of computing systems, model structures, and data flows for illustration purposes only.

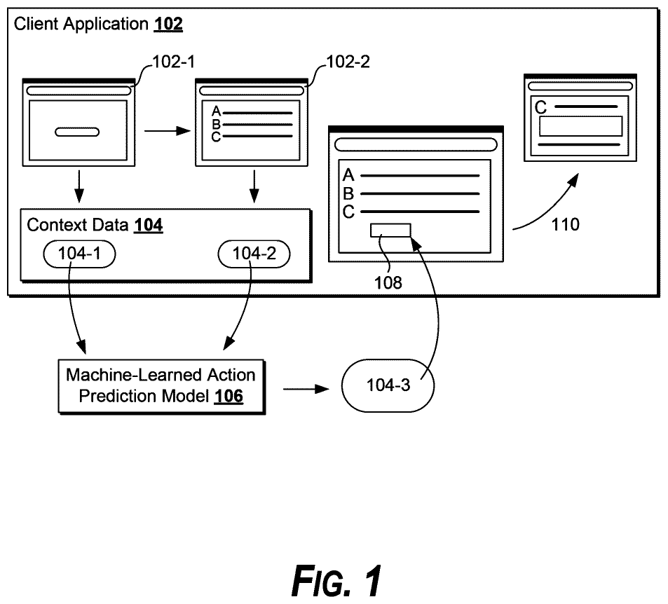

FIG. 1 illustrates an example shortcut generation system according to the present disclosure. A client device can implement a client application 102 (e.g., a browser). Client application 102 can maintain a set of context data 104 which can maintain a trace of recent actions taken in client application 102. Client application 102 can provide an first interface for submitting a search query. One or more action indicators 104-1 can represent aspects of this first action. Client application 102 can process a search query and present a list of search results. One or more action indicators 104-2 can represent aspects of this second action. Based on one or more action indicators in context data 104, machine-learned action prediction model 106 can generate a prediction of one or more predicted action indicators 104-3. Predicted action indicator(s) 103 can indicate a resource locator of an action interface for performing an action. The action interface can correspond to one of the web resources retrieved in the search results (e.g., result C in FIG. 1). Client application 102 can augment the list of search results with a shortcut 108 rendered in association with the corresponding search result (e.g., an input element rendered in association with result C). Shortcut 108 can be configured to, when selected, cause client application 102 load, at 110, the action interface using the resource locator obtained via predicted action indicator(s) 103.

Client application 102 can be or include an application configured for obtaining and presenting web resources. Client application 102 can be or include a browser application or interface. Client application 102 can be implemented by one or more components of an operating system of a computing device. Client application 102 can be a mobile application. Client application 102 can be a web-based application. Client application 102 can include a conversational assistant interface configured to receive natural language queries, provide the queries to a machine-learned conversational assistant model (e.g., an on-device model, a cloud-hosted model), receive responses to the queries, and output the responses to the user. Client application 102 can provide a chat-based conversational interface.

Client application 102 can provide at 102-1 an input interface for inputting a query. The query can be a search query for retrieving web-based search results. The search results can be web resources, such as web pages, web applications, or other information or data obtained over the Internet. For instance, client application 102 can process the query (e.g., by sending the query to a cloud-hosted search system) and obtain a set of results. The set of results can be output via a user interface to the user at application state 102-2.

Client application 102 can augment the search results with one or more shortcuts. A shortcut can be a direct link to a predicted destination of interest for accomplishing a task or performing an action. The shortcut can, when selected, cause client application 102 to load an action interface for performing an action with a web resource. For instance, an action interface can be a web page or web application configured for performing an action. Example actions include data input, query submission, purchase initiation or completion, data consumption, etc. For instance, an action associated with a web resource for an auto insurance company can include obtaining a quote, obtaining information about insurance plans, reviewing contact information for the insurance company, reviewing plan information comparing insurance plans, etc. Action interfaces for such example actions can include data input field(s) for submitting a request for a quote, plan summary pages that display information about insurance plans, a contact information page or a question-submission field, a comparison table comparing insurance plans, etc. In another example, an action associated with a restaurant web resource can include viewing a menu or making a reservation. An action interface for such example actions can include a page or document displaying the menu or an interface for securing a reservation (e.g., using the restaurant website, using a different website, using a native reservation application, etc.). A search query for the restaurant (e.g., the restaurant name) can return a result linking to the restaurant website. This search result can thus be augmented with a shortcut linking to the page or document displaying the menu, a shortcut linking to a reservation request page of the restaurant website or a different website or a native reservation application installed alongside client application 102, etc.

Context data 104 can facilitate generating shortcuts by providing machine-learned action prediction model 106 with relevant cues for predicting an action to be taken with respect to the search result(s) and outputting a corresponding resource locator for linking to an interface for performing the action. Context data 104 can include current or past state data of the device executing client application 102. State data can include location data, sensor data (e.g., temperature, inertial, photonic, etc.). Context data 104 can include current or past application data (e.g., client application 102), including application logs or traces. Context data 104 can include a sequence of one or more actions performed using the application. Context data 104 can include query content, search result content, account preference content, etc. For instance, context data 104 can include a sequence of one or more resource locators of resources presented via client application 102. Context data 104 can include content describing a current or past task, query, search, request, etc. in natural language, markup language (e.g., html, xml, etc.), code, or an embedding space. Context data 104 can include natural language content describing current or past resources downloaded and rendered by application 102 in natural language, markup language (e.g., html, xml, etc.), code, or an embedding space. Context data 104 can include instructions for model 106 to execute in natural language, markup language (e.g., html, xml, etc.), code, or an embedding space.

Context data 104 can include user-generated content. The content can be generated by one or more users of one or more instances of client application 102 on the same or multiple devices. The user-generated content can include link notes that record contextual information regarding web resources associated with a given link or landing page. A user-generated link note can include data indicating information associated with the quality of the web resource or the content contained therein (e.g., a product review), landing pages utilized, and/or actions performed. A link note can include text provided with the search result information of a search result (e.g., the link note may be provided with the web resource title, hyperlink, and caption). A link note can include reviews and/or other user-generated content can include details associated with how a user utilized the web page, what they saw on the web page, and/or their review of the quality of that web resource. In some implementations, the link note can include a multimodal user-generated content item that may include text overlaid by a graphical card with one or more media content items (e.g., images and/or videos).

Context data 104 can be obtained from a database associated with a web search server. Context data 104 can be obtained from a downloaded search results page directly. An example search results interface can provide one or more link notes for display a query result. The link note can then be passed as input to machine-learned action prediction model 106.

For instance, action indicator(s) 104-1 can represent an action associated with application state 102-1. The action indicator 104-1 can represent a resource locator associated with a search action. The action indicator 104-1 can be or include an embedded value. For instance, a resource locator can be processed by one or more tokenizing or embedding layers of a machine-learned model to generate action indicator 104-1 representing the action associated with the resource locator. Action indicator(s) 104-1 can include a single token corresponding to the resource locator (e.g., a word-level token with the resource locator as one “word”). Action indicator(s) 104-1 can include multiple tokens corresponding to the resource locator (e.g., multiple subword-level tokens with the resource locator being a “word” composed of multiple component subwords).

Other context data 104 can be embedded with the resource locator. For instance, additional dimensions can be added to the embedding vector to represent an embedding of the context data. Context data can be embedded directly with the resource locator in the same vector.

Action indicator(s) 104-2 can represent an action associated with application state 102-2. The action indicator 104-2 can represent a resource locator associated with a search result or search result listing. The action indicator 104-2 can be or include an embedded value. For instance, a resource locator can be processed by one or more tokenizing or embedding layers of a machine-learned model to generate action indicator 104-2 representing the action associated with the resource locator. Action indicator(s) 104-2 can include a single token corresponding to the resource locator (e.g., a word-level token with the resource locator as one “word”). Action indicator(s) 104-2 can include multiple tokens corresponding to the resource locator (e.g., multiple subword-level tokens with the resource locator being a “word” composed of multiple component subwords).

Other context data 104 can be embedded with the resource locator. For instance, additional dimensions can be added to the embedding vector to represent an embedding of the context data. Context data can be embedded directly with the resource locator in the same vector.

Action indicator(s) 104-2 can be associated with a web resource listing search results. Action indicator(s) 104-2 can be associated with one or more of the search results. Action indicator(s) 104-2 can represent a resource locator of a search result.

An action or data descriptive of an action (e.g., action indicator 104-1, 104-2, etc.) can include data in a format of [Action name, Action URL, Suggestive data elements]. The data can be rearranged or omitted as desired. Other data can be included. Other formats can be used.

Machine-learned action prediction model 106 can process additional context data in conjunction with one or more action indicators. For instance, along with one or more tokens or embeddings associated with one or more action indicators, context data 104 can also include one or more tokens or embeddings providing additional contextual information from other data types of context data 104. For instance, along with one or more tokens or embeddings associated with one or more action indicators, context data 104 can also include a tokenized description of a site map for a given search result, a markup representation of a landing page associated with a search result, etc.

Machine-learned action prediction model 106 can process context data 104 (e.g., one or more of action indicator(s) 104-1 and 104-2) to output predicted action indicator(s) 104-3. Machine-learned action prediction model 106 can be or include various neural network architectures. Machine-learned action prediction model 106 can include a sequence-to-sequence model. Machine-learned action prediction model 106 can include transformer model architecture. Machine-learned action prediction model 106 can be configured to receive a sequence of action indicators and output a predicted action indicator.

Machine-learned action prediction model 106 can learn to obtain a probability distribution over possible predicted action indicator values. Machine-learned action prediction model 106 can include, for example, output layer(s) that compute an estimated probability distribution over a vocabulary of possible predicted action indicator values. Machine-learned action prediction model 106 can include, for example, output layer(s) that emit a logit for an indicator in a vocabulary of indicators. For instance, machine-learned action prediction model can include a vocabulary of resource locators, and output layer(s) of machine-learned action prediction model 106 can compute an estimated probability that a particular resource locator is associated with a sequence of one or more input resource locators.

Machine-learned action prediction model 106 can learn to generate predicted action indicator(s) 104-3 from subcomponents. For instance, a predicted action indicator 104-3 can include or represent a resource locator. A resource locator can be a URL string that has different subcomponents. For instance, subcomponents can include: top-level domain, subdomain, second-level domain or domain name, geographic domain, subdirectory or file path, query strings or parameters, fragment indicators, etc. Other subcomponent schemas may be used. Machine-learned action prediction model 106 can include a vocabulary built of subcomponents for resource locators. For instance, such subcomponents can be “words” of an output vocabulary. In this manner, then, machine-learned action prediction model 106 can output sequences of subcomponents. Machine-learned action prediction model 106 can autoregressively predict a next subcomponent based on any preceding subcomponents.

Machine-learned action prediction model 106 can generate an output token that corresponds to an input resource locator for a predicted action indicator 104-3. For instance, an input sequence can include a plurality of candidate resource locators. Machine-learned action prediction model 106 can process the plurality of candidate resource locators in view of context data 104 to generate an output token that corresponds to the input resource locator of the predicted action indicator 104-3.

Machine-learned action prediction model 106 can be configured to obtain predicted action indicator(s) 104-3 by matching the input sequence to a verified action indicator. The matching can be performed by a machine-learned action prediction model 106. A computing system can maintain a set of validated action sequences. For instance, one or more entities associated with a web resource can approve a validated action sequence. For example, an entity associated with a given domain can approve validated action sequences leading to action interfaces associated with the domain. For instance, an entity associated with an auto insurance website can approve a sequence of actions including a search query for auto insurance quotes, the auto insurance website, and an action interface for submitting a request for an auto insurance quote.

Predicted action indicator(s) 104-3 can represent an action associated with a predicted application state. Predicted action indicator(s) 104-3 can be or represent a resource locator associated with an action interface for performing an action associated with a search result. Predicted action indicator(s) 104-3 can be or include an embedded value. For instance, a resource locator can be decoded from prediction action indicator(s) 104-3 by one or more output layers of a machine-learned model. Other context data 104 can be embedded with the resource locator. For instance, additional dimensions can be added to the embedding vector to represent an embedding of the context data. Context data can be embedded directly with the resource locator in the same vector.

An output filter mechanism can be applied to outputs of machine-learned action prediction model 106 to constrain outputs to a validated set of predicted actions (e.g., a set of validated action sequences). For instance, a computing system can compare a predicted action indicator with a validated set of action indicators provided by one or more entities associated with the predicted action indicator (e.g., hosting an action interface located at the predicted action indicator).

An output filter mechanism can be applied to outputs of machine-learned action prediction model 106 to constrain outputs to an approved set of web resources. For instance, some web resource owners or operators may desire that shortcuts not be provided in association with their web resources. As such, an output filter can be applied to filter out any predicted actions associated with an unapproved resource. For instance, a filter can be applied on a domain of a resource locator for the shortcut. Similarly, a filter can be used to only generate predicted actions for a search result associated with an approved web resource. For instance, shortcut generation can be a service provided to a defined set of participating resource owners or operators, such that only search results relating to their resources are augmented with shortcuts.

Shortcut 108 can be an input element added to the results list in application state 102-2. Client application 102 can augment a rendering of the search results list by adding the shortcut 108 in association with a related search result. For instance, an action interface predicted for a particular search result can be linked by rendering shortcut 108 in association with that particular search result. For instance, shortcut 108 can include an executable hyperlink added to an html markup file rendered by a browser.

Additional information can be rendered with the related search result. For example, link notes can be rendered along with the shortcut to the resource locator. The one or more link notes may be general link notes associated with the particular web resource. The one or more link notes can be selected based on the content of the landing page associated with the shortcut (e.g., link notes associated with reserving a table may be identified and provided for display based on the shortcut being associated with a landing page for booking a table at the restaurant associated with the web resource).

Interacting with shortcut 108 can cause client application 102 to load at 110 an action interface associated with one of the retrieved search results. For instance, shortcut 108 can include a hyperlink that, when executed, initiates loading of a web resource containing the action interface. For instance, client application 102 can be a browser that displays shortcut 108 in association with a search result of a restaurant website. Executing shortcut 108 can trigger loading of a page of a restaurant reservation website having an action interface configured for requesting a reservation at the restaurant.

Interacting with shortcut 108 can cause another application (e.g., other than client application 102) to load an action interface associated with one of the retrieved search results. For example, shortcut 108 can include a deep link that, when executed, initiates loading of another application to provide an action interface. For instance, client application 102 can be a browser that displays shortcut 108 in association with a search result of a restaurant website. Executing shortcut 108 can trigger activation of a restaurant reservation application having an action interface configured for requesting a reservation at the restaurant.

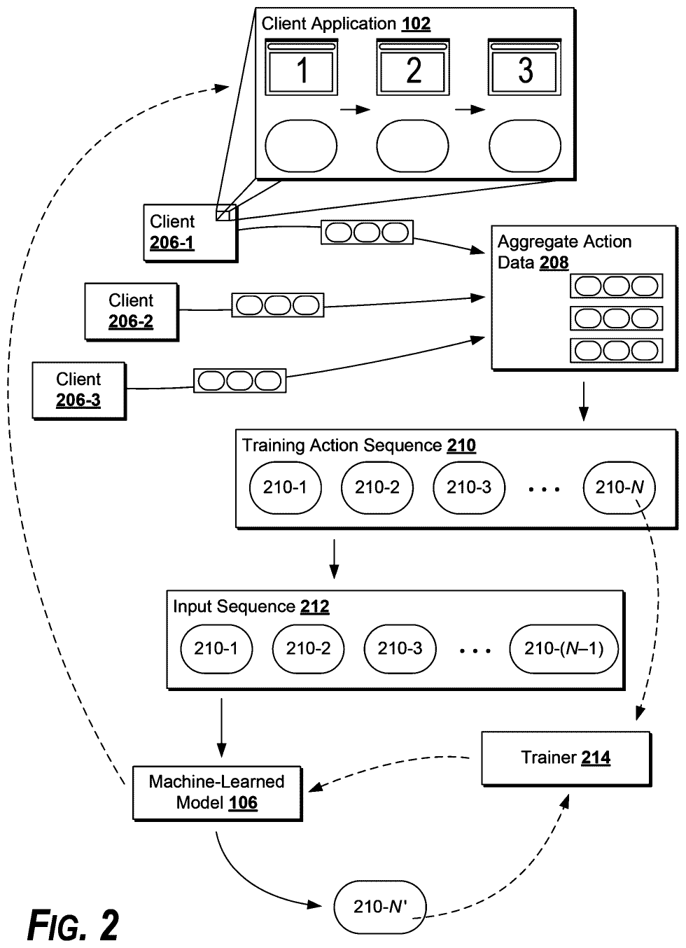

FIG. 2 illustrates an example training technique for training a machine-learned action prediction model. A plurality of clients 206-1, 206-2, and 206-3 can execute a client application 102. The clients can use client application 102 to load to initiate loading of various resources, such as web resources (e.g., using URLs) or native applications (e.g., using deep links). Client application 102 can log sequences in which the various resources are loaded. The client devices 206-1, 206-2, 206-3 can privatize (e.g., noise, strip PII, etc.) and upload this log data to a server to form aggregate action data 208. Aggregate action data 208 can contain training action sequence 210 containing action indicators 210-1, 210-2, 210-3, . . . , 210-N. Drawn from training action sequence 210, input sequence 212 can contain action indicators 210-1, 210-2, 210-3, . . . , 210-(N-1), with the subsequent action indicator 210-N omitted. Machine-learned action prediction model 106 can process input sequence 212 to generate a predicted action indicator 210-N′. Trainer 214 can evaluate how well predicted action indicator 210-N′ aligns with ground truth action indicator 210-N. Trainer 214 can initiate updates to one or more learnable parameters of machine-learned action prediction model 106. A computing system can distribute updated machine-learned action prediction model 106 to one or more client devices, such as clients 206-1, 206-2, 206-3, although it is to be understood that aggregate action data 208 can include data obtained from clients that do not implement machine-learned action prediction model 106.

Clients 206-1, 206-2, 206-3 can be or include one or more computing devices. Clients 206-1, 206-2, 206-3 can each implement a version of client application 102. Clients 206-1, 206-2, 206-3 can use client application 102 to navigate from one web resource to another. Client application 102 can generate log data tracing a sequence of web resources. The log data can include action indicators for each loaded resource. The action indicators can include a resource locator for the loaded resource. The log data can include sequences of resource locators. The log data can include other context data.

Client application 102 can detect, when processing web resources, a request to not be logged. For instance, some web resource owners or publishers may wish to decline participation in the action sequence logging. These entities can add, to the web resource, data indicating a request to not participate. Client application 102 can omit such web resources from the log data. Client application 102 can terminate a logged sequence with the preceding web resource and initiate a new logged sequence with the next permitted web resource.

Clients 206-1, 206-2, 206-3 can privatize the log data before upload to the server. Clients 206-1, 206-2, 206-3 can implement any variety of data manipulation techniques to increase privacy of the log data. Clients 206-1, 206-2, 206-3 can add noise to the log data. Clients 206-1, 206-2, 206-3 can strip the log data of any personal identifying information (e.g., any resource locators that would reveal PII). Clients 206-1, 206-2, 206-3 can opt out of participating in the training cycle.

Aggregate action data 208 can aggregate the logged action data received from participating clients. Aggregate action data 208 can be further privatized to adhere to one or more privacy metrics. For instance, aggregate action data 208 can be configured to satisfy a differential privacy metric, such that the absence of any particular client's contribution would not alter the composition of the aggregate data within an epsilon value.

Aggregate action data 208 can be filtered based on one or more policies. An approval policy can be used to determine whether an action sequence is approved for use in training data. For instance, an entity associated with a web resource can request that its web resources not be used for shortcut generation. In this manner, for instance, machine-learned action prediction model 106 can be trained without reference to the action indicators associated with that web resource and client application 102 can be configured to not invoke machine-learned action prediction model 106 to generate shortcuts associated with that web resource.

Validated action sequences can be obtained by analysis of aggregate action data 208. Observed action sequences that appear with more frequency can be associated with successful interactions (e.g., successful navigation to a desired action interface). Action sequences can be validated in this manner in some examples.

Training action sequence 210 can be drawn from aggregate action data 208. Training action sequence 210 can be sampled (e.g., randomly sampled) from aggregate action data 208. Training action sequence 210 can be obtained by sliding a window over sequential action indicators in aggregate action data 208. The window can be configured with various sequence lengths.

Input sequence 212 can be obtained from training action sequence 210 by dropping, replacing, obscuring, or otherwise altering one or more of the action indicators in training action sequence 210. Machine-learned action prediction model 106 can attempt to predict the missing indicator based on the preceding indicators. Trainer 214 can use the omitted or altered action indicator as a ground truth reference for evaluating the quality of the predictions. In this manner, for instance, the system can perform a type of self-supervised learning.

Input sequence 212 can include additional context data (e.g., context data 104) along with one or more of the action indicators. Input sequence 212 can include any one or more data items described above with respect to context data 104 that could be available at inference time.

Input sequence 212 can include link notes, reviews, or other user-generated content. Such content can provide quality signals or content indicators for training the machine-learned action prediction model. For example, the reviews or other user-generated content can include details associated with how a user utilized the web page, what they saw on the web page, or their review of the quality of that web resource. The user-generated content can be used directly (e.g., directly input to the model during training as a context signal) or can be pre-processed into label categories. For instance, a pre-processing system can process the details of the reviews or other user-generated content to generate labels for web resources. For instance, a machine-learned model can process the details to identify particular actions discussed in the reviews or other user-generated content. The labels can then be used for machine-learned action prediction model training.

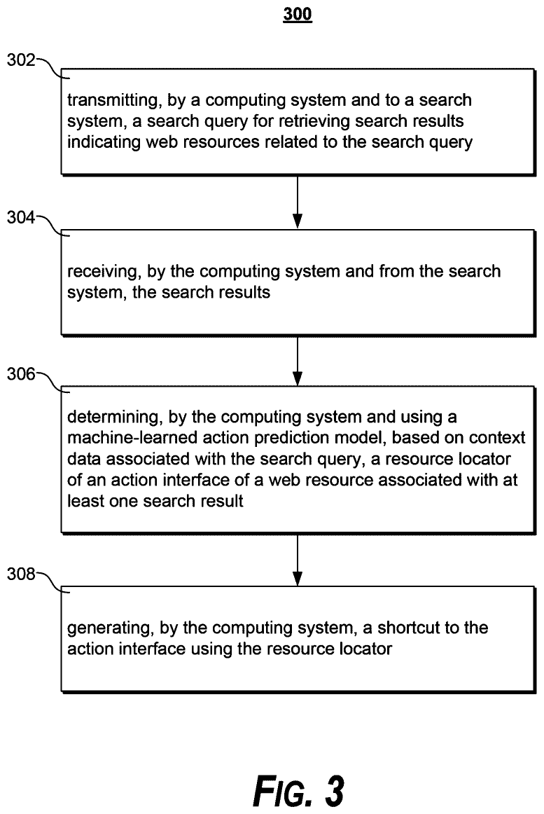

FIG. 3 depicts a flow chart diagram of an example method 300 to perform according to example embodiments of the present disclosure. Example method 300 can be implemented by one or more computing systems (e.g., one or more computing systems as discussed with respect to any of the figures herein). Although FIG. 3 depicts steps performed in a particular order for purposes of illustration and discussion, the methods of the present disclosure are not limited to the particularly illustrated order or arrangement. The various steps of example method 300 can be omitted, rearranged, combined, and/or adapted in various ways without deviating from the scope of the present disclosure.

At 30, example method 300 can include transmitting, by a computing system and to a search system, a search query for retrieving search results indicating web resources related to the search query. For instance, the computing system can operate a client application 102 for submitting web search queries to a web search system.

At 304, example method 300 can include receiving, by the computing system and from the search system, the search results. For instance, client application 102 can receive a list of search results (e.g., at 102-2).

At 306, example method 300 can include determining, by the computing system and using a machine-learned action prediction model, based on context data associated with the search query, a resource locator of an action interface of a web resource associated with at least one search result. For instance, context data 104 can be based on one or more states of client application 102. Context data 104 can include a sequence of actions. Context data 104 can include a sequence of resource locators loaded by client application 102. Machine-learned model 106 can process context data 104 to generate a predicted action that can include a resource locator of an action interface of a web resource associated with at least one search result.

At 308, example method 300 can include generating, by the computing system, a shortcut to the action interface using the resource locator. For instance, shortcut 108 can be generated based on the determined resource locator(s).

In some implementations, example method 300 includes generating, by the computing system, an input to the machine-learned action prediction model, wherein the input includes a sequence of web resources accessed prior to transmission of the search query. For instance, context data 104 can include a sequence of actions. Context data 104 can include a sequence of resource locators loaded by client application 102. Context data can include at least one data type selected from the following list: user account data, location data, or sensor data.

In some implementations, example method 300 includes locally processing, by the computing system, the context data with the machine-learned action prediction model. For instance, the machine-learned action prediction model can be executed on a device that also executes client application 102.

In some implementations, example method 300 includes generating, by the computing system and using the machine-learned action prediction model, a score associated with the resource locator. For instance, the score can correspond to a confidence or a likelihood that the resource locator would be a destination associated with the context data. In some implementations, example method 300 includes determining, by the computing system and based on the score, to generate the shortcut using the resource locator.

In some implementations, example method 300 includes generating, by the computing system and using the machine-learned action prediction model, a plurality of scores associated with a plurality of resource locators. For instance, the machine-learned action prediction model can rank a plurality of possible or candidate resource locators. For instance, the machine-learned action prediction model can implement a softmax operation to determine a probability distribution over a vocabulary of resource locators. In some implementations, example method 300 includes determining, by the computing system and based on the score, to generate a plurality of shortcuts using a top-ranked set of the plurality of resource locators; and outputting, by the computing system, the plurality of shortcuts with the at least one search result. For instance, the search result can correspond to multiple popular actions. A shortcut can be generated for each. For instance, based on distances between scores for the top K resource locators, a cluster of top resource locators can be selected for use in generating corresponding shortcuts.

In some implementations, example method 300 includes inputting, by the computing system, the context data into the machine-learned action prediction model, wherein the context data includes a set of one or more runtime actions. The runtime actions can include a set of actions performed by client application 102 at runtime during the same or preceding sessions. In some implementations, example method 300 includes outputting, by the computing system, a predicted action in a sequence of actions including the one or more runtime actions (e.g., an action predicted to follow the runtime actions, either immediately follow or follow after one or more intervening actions).

In some implementations of example method 300, the machine-learned action prediction model outputs a representation of the resource locator.

In some implementation of example method 300, the respective training action sequence includes a first resource locator associated with a first web resource accessed at a first time. In some implementation of example method 300, the respective training action sequence includes a second resource locator associated with a second web resource accessed at a second time subsequent to the first time.

In some implementation of example method 300, the context data includes data representing contents of the web resource (e.g., embedded representations of content of the resource). In some implementation of example method 300, the context data includes data representing a sitemap associated with the web resource. In some implementation of example method 300, the context data includes data representing resource locators for a plurality of web resources related to the web resource. In some implementation of example method 300, the context data includes data representing resource locators for a plurality of web resources that share a domain with the web resource.

In some implementations, example method 300 includes inputting, by the computing system and to the machine-learned action prediction model, the data representing resource locators for the plurality of web resources that share the second-level domain with the web resource. In some implementations, example method 300 includes selecting, by the computing system and using the machine-learned action prediction model, the resource locator from the data representing resource locators for the plurality of web resources that share the second-level domain with the web resource.

In some implementations, example method 300 includes obtaining, by the computing system, a verified set of action sequences. In some implementations, example method 300 includes determining, by the computing system and using the machine-learned action prediction model, the resource locator by: determining a relevant action sequence of the verified set of action sequences, the relevant action sequence related to the web resource associated with the at least one search result, and returning the resource locator associated with the action interface.

In some implementations of example method 300, the machine-learned action prediction model is a transformer model.

In some implementations of example method 300, the machine-learned action prediction model is configured to process, as an input, a sequence of tokens representing one or more resource locators. In some implementations of example method 300, the machine-learned action prediction model is configured to output a sequence of tokens representing one or more resource locators. In some implementations of example method 300, a token represents one or more subportions of a resource locator. In some implementations of example method 300, a token represents an entire resource locator.

In some implementations of example method 300, example method 300 is performed by a browser application.

In some implementations, example method 300 includes determining, by the computing system, that the web resource does not comprise an opt-out indicator to opt out of the action prediction.

In some implementations, example method 300 includes caching by the computing system, action sequences performed by the browser. In some implementations, example method 300 includes uploading, by the computing system and to a training system, the cached action sequences. In some implementations, example method 300 includes receiving, by the computing system, an updated machine-learned action prediction model trained using the cached action sequences.

In some implementations of example method 300, the machine-learned action prediction model is trained using federated learning. In some implementations of example method 300, the machine-learned action prediction model is trained using differentially private federated learning.

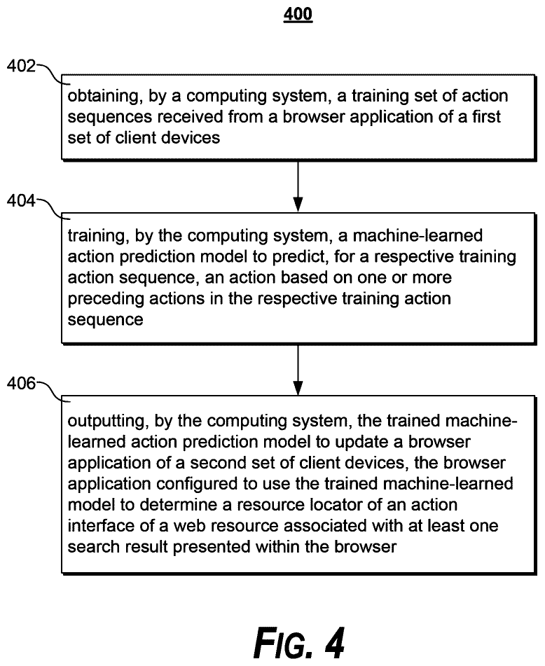

FIG. 4 depicts a flow chart diagram of an example method 400 to perform according to example embodiments of the present disclosure. Example method 400 can be implemented by one or more computing systems (e.g., one or more computing systems as discussed with respect to any of the figures herein). Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include obtaining, by a computing system, a training set of action sequences received from a browser application of a first set of client devices

At 404, example method 400 can include training, by the computing system, a machine-learned action prediction model to predict, for a respective training action sequence, an action based on one or more preceding actions in the respective training action sequence

At 406, example method 400 can include outputting, by the computing system, the trained machine-learned action prediction model to update a browser application of a second set of client devices, the browser application configured to use the trained machine-learned model to determine a resource locator of an action interface of a web resource associated with at least one search result presented within the browser.

In some implementations of example method 400, a respective training action sequence of the training set includes a first resource locator associated with a first web resource accessed at a first time. In some implementations of example method 400, a respective training action sequence of the training set includes a second resource locator associated with a second web resource accessed at a second time subsequent to the first time.

In some implementations, example method 400 includes generating, by the computing system, a verified set of action sequences. In some implementations, example method 400 includes training, by the computing system, the machine-learned action prediction model on the verified set of action sequences.

In some implementations, example method 400 includes verifying, by the computing system, an action sequence using a machine-learned verification model.

In some implementations, example method 400 includes verifying, by the computing system, an action sequence based on a measure of recurrence of the action sequence in the training set.

In some implementations of example method 400, an action of the action sequence comprises a resource locator for a web resource.

In some implementations, example method 400 includes generating, by the computing system, a context feature for the action based on the resource locator for the action.

In some implementations of example method 400, the machine-learned action prediction model is a transformer model.

In some implementations of example method 400, the machine-learned action prediction model is configured to process, as an input, a sequence of tokens representing one or more resource locators. In some implementations of example method 400, the machine-learned action prediction model is configured to output a sequence of tokens representing one or more resource locators. In some implementations of example method 400, a token represents one or more subportions of a resource locator. In some implementations of example method 400, a token represents an entire resource locator.

In some implementations, example method 400 includes training the machine-learned action prediction model according to implementations of example method 400.

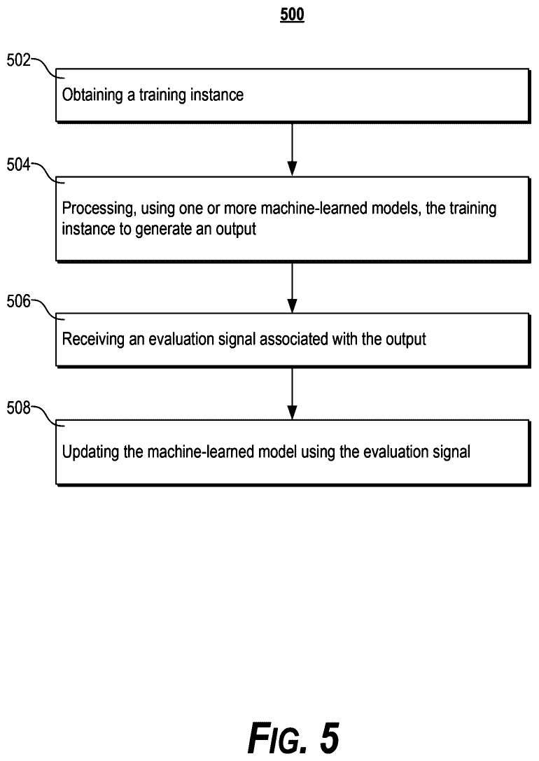

FIG. 5 depicts a flowchart of a method 500 for training a machine-learned model according to example aspects of the present disclosure. One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein. One or more non-transitory computer-readable media can store instructions that are executable to perform one or more operations, the operations including one or more parts or aspects of example method 500.

FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

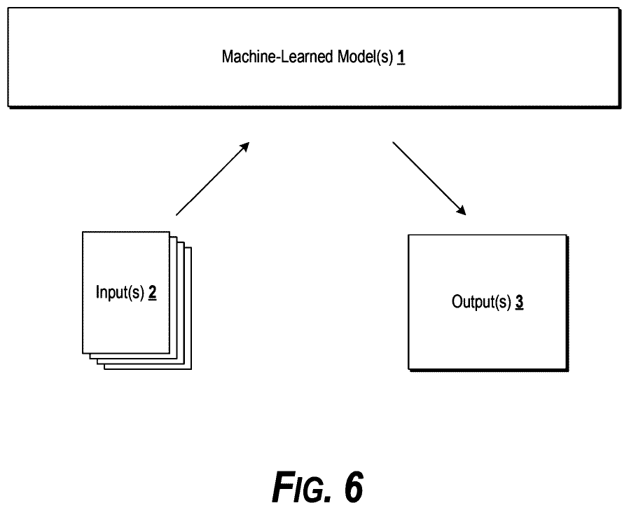

FIG. 6 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., model 106, etc.). For example, any one or multiple of machine-learned models 106, etc. can be a machine-learned model 1. Features and variations described herein with respect to machine-learned model 1 are to be understood as describing features and variations of any of the machine-learned models described herein. Where this description references machine-learned model 1 it is to be understood that implementations of each of the other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data.

Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

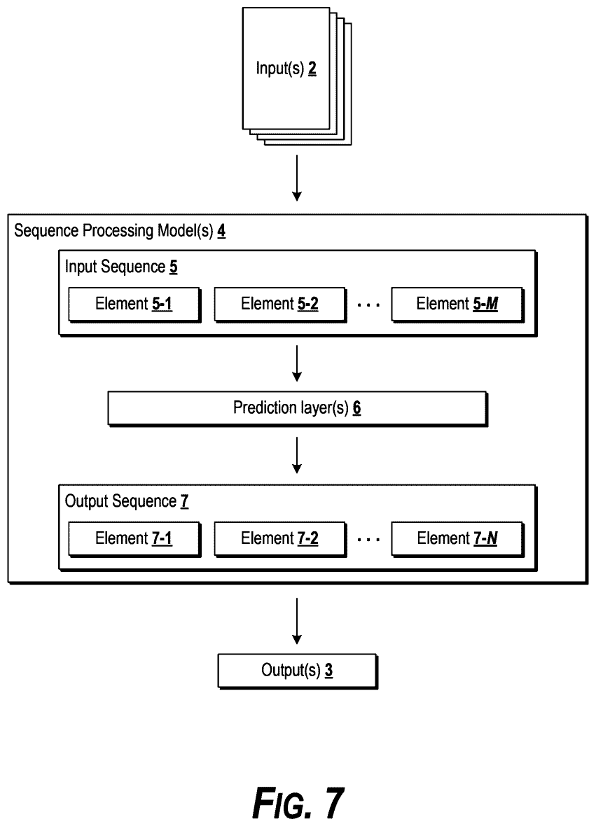

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

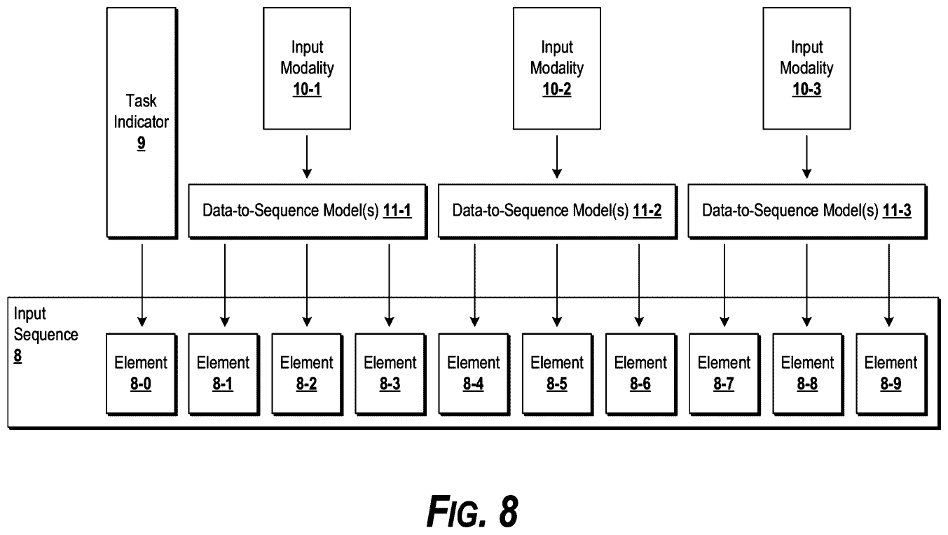

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

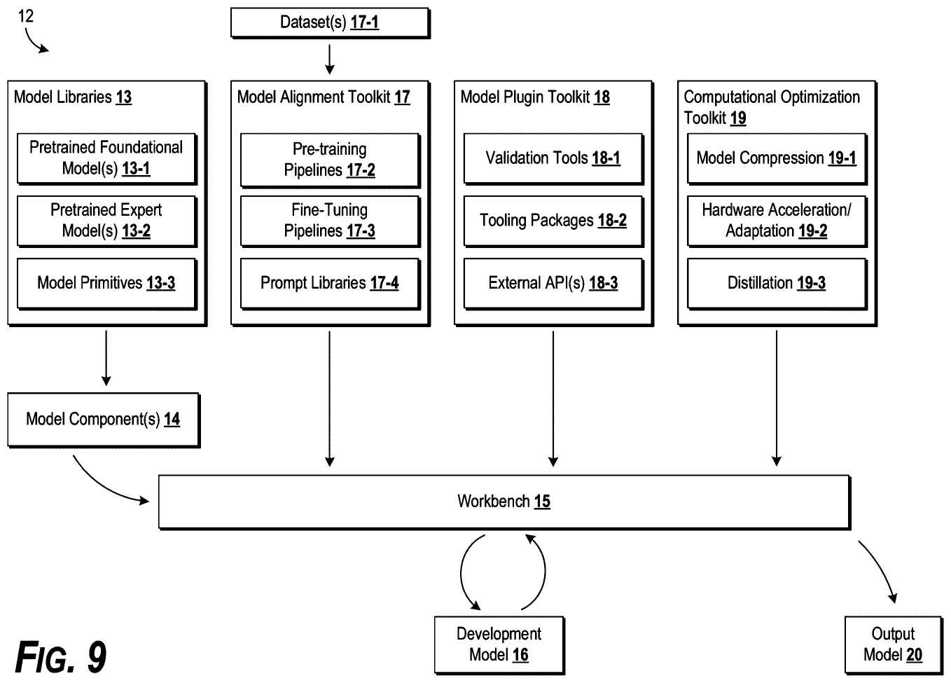

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

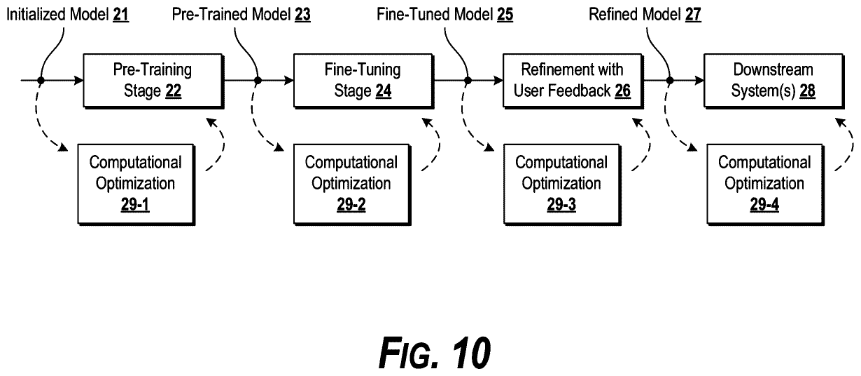

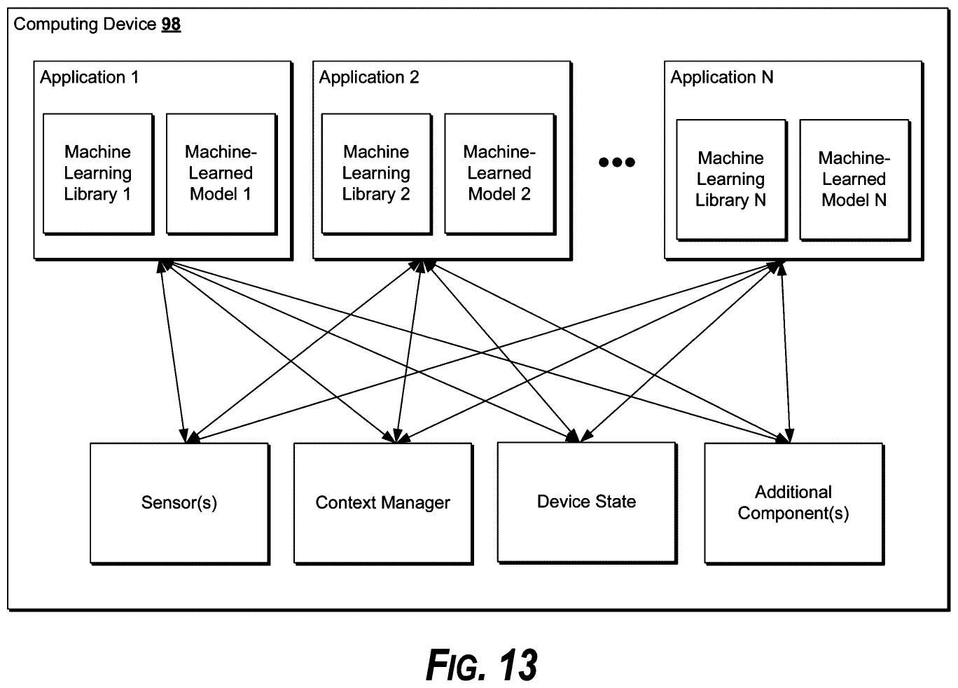

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

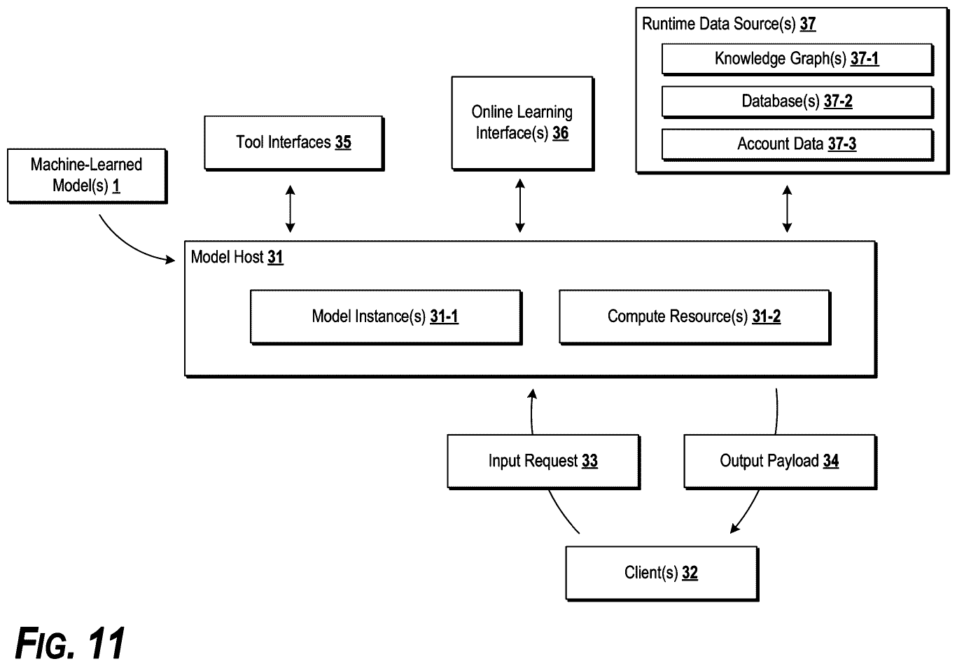

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function).

Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s).

Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

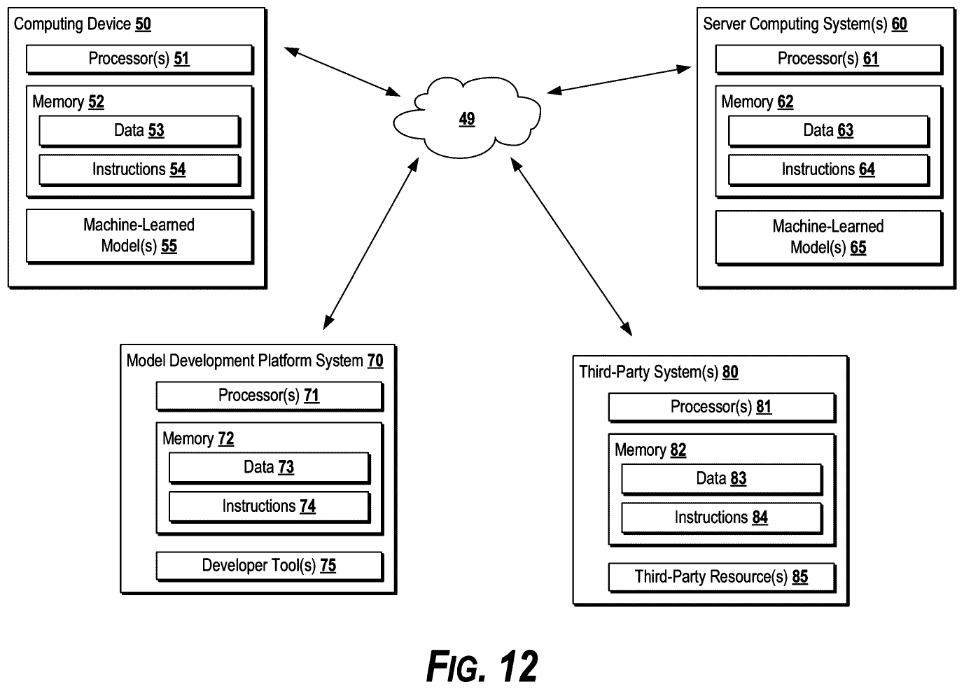

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52.

Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof.

Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

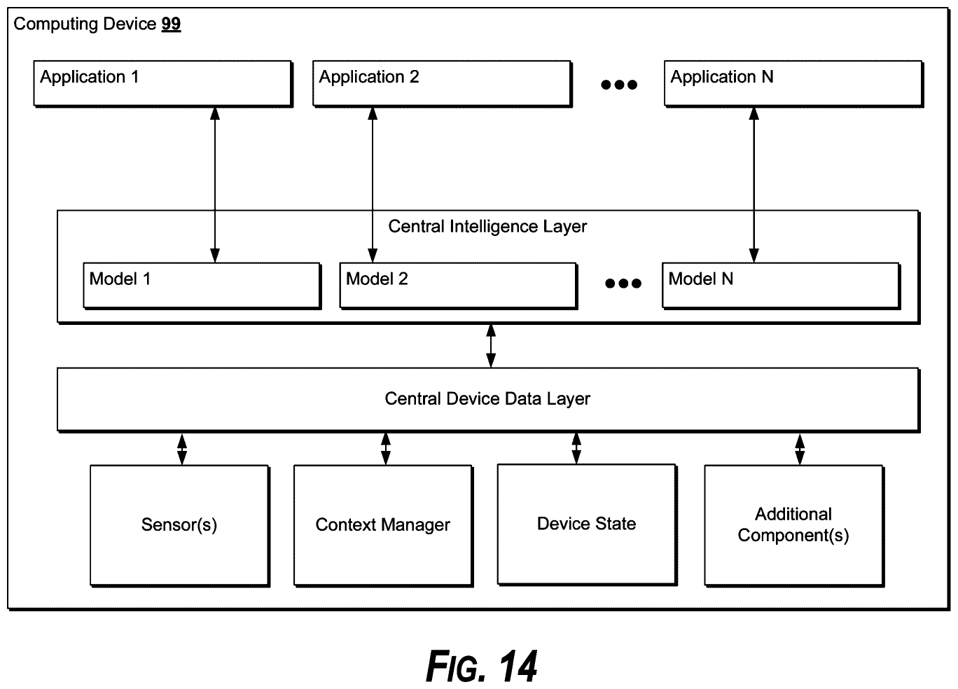

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models.

For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method, the method comprising:
transmitting, by a computing system and to a search system, a search query for retrieving search results indicating web resources related to the search query;
receiving, by the computing system and from the search system, the search results;
determining, by the computing system and using a machine-learned action prediction model, based on context data associated with the search query, a resource locator of an action interface of a web resource associated with at least one search result, wherein the machine-learned action prediction model was trained using a training set of action sequences, a respective training action sequence describing an order in which web resources were accessed;
generating, by the computing system, a shortcut to the action interface using the resource locator; and
outputting, by the computing system on a user interface, the at least one search result and the shortcut.

2. The computer-implemented method of claim 1, comprising:
generating, by the computing system, an input to the machine-learned action prediction model, wherein the input comprises a sequence of web resources accessed prior to transmission of the search query,

3. The computer-implemented method of claim 1, wherein the context data comprises at least one data type selected from the following list: user account data, location data, or sensor data.

4. (canceled)

5. (canceled)

6. The computer-implemented method of claim 1, comprising:
generating, by the computing system and using the machine-learned action prediction model, a plurality of scores associated with a plurality of resource locators;
determining, by the computing system and based on the score, to generate a plurality of shortcuts using a top-ranked set of the plurality of resource locators; and
outputting, by the computing system, the plurality of shortcuts with the at least one search result.

7. The computer-implemented method of claim 1, comprising:
inputting, by the computing system, the context data into the machine-learned action prediction model, wherein the context data comprises a set of one or more runtime actions; and
outputting, by the computing system, a predicted action in a sequence of actions comprising the one or more runtime actions.

8. The computer-implemented method of any of claim 1, wherein the machine-learned action prediction model outputs a representation of the resource locator.

9. (canceled)

10. The computer-implemented method of claim 1, wherein the context data comprises data representing contents of the web resource.

11. The computer-implemented method of claim 1, wherein the context data comprises data representing a sitemap associated with the web resource.

12. (canceled)

13. (canceled)

14. The computer-implemented method of claim 1, comprising:
inputting, by the computing system and to the machine-learned action prediction model, the data representing resource locators for a plurality of web resources that share a second-level domain with the web resource; and
selecting, by the computing system and using the machine-learned action prediction model, the resource locator from the data representing resource locators for the plurality of web resources that share the second-level domain with the web resource.

15. The computer-implemented method of claim 1, comprising:
obtaining, by the computing system, a verified set of action sequences; and
determining, by the computing system and using the machine-learned action prediction model, the resource locator by:
determining a relevant action sequence of the verified set of action sequences, the relevant action sequence related to the web resource associated with the at least one search result; and
returning the resource locator associated with the action interface.

16. (canceled)

17. The computer-implemented method of claim 1, wherein the machine-learned action prediction model is configured to process, as an input, a sequence of tokens representing one or more resource locators.

18. The computer-implemented method of claim 1, wherein the machine-learned action prediction model is configured to output a sequence of tokens representing one or more resource locators.

19. The computer-implemented method of claim 18, wherein a token of the sequence of tokens represents one or more subportions of a resource locator.

20. The computer-implemented method of claim 18, wherein a token of the sequence of tokens represents an entire resource locator.

21. The computer-implemented method of claim 1, performed by a browser application.

22. (canceled)

23. The computer-implemented method of claim 21, comprising:
caching, by the computing system, action sequences performed by the browser;
uploading, by the computing system and to a training system, the cached action sequences; and
receiving, by the computing system, an updated machine-learned action prediction model trained using the cached action sequences.

24. (canceled)

25. (canceled)

26. (canceled)

27. A computer-implemented method, comprising:
obtaining, by a computing system, a training set of action sequences received from a browser application of a first set of client devices;
training, by the computing system, a machine-learned action prediction model to predict, for a respective training action sequence, an action based on one or more preceding actions in the respective training action sequence;
outputting, by the computing system, the trained machine-learned action prediction model to update a browser application of a second set of client devices, the browser application configured to use the trained machine-learned model to determine a resource locator of an action interface of a web resource associated with at least one search result presented within the browser.

28. The computer-implemented method of claim 27, wherein a respective training action sequence of the training set comprises:
a first resource locator associated with a first web resource accessed at a first time; and
a second resource locator associated with a second web resource accessed at a second time subsequent to the first time.

29. The computer-implemented method of claim 27, comprising:
generating, by the computing system, a verified set of action sequences; and
training, by the computing system, the machine-learned action prediction model on the verified set of action sequences.

30. The computer-implemented method of claim 29, comprising:
verifying, by the computing system and based on a measure of recurrence of the action sequence in the training set, an action sequence using a machine-learned verification model.

31. (canceled)

32. (canceled)

33. (canceled)

34. (canceled)

35. (canceled)

36. (canceled)

37. (canceled)

38. (canceled)

39. (canceled)

40. (canceled)

41. (canceled)
